(19) United States
(12) Patent Application Publication
(10) Pub. No.: US 2014/0259532 A1
(43) Pub. Date: Sep. 18, 2014

(54) LOCKING HINGE AND CLAMPING DEVICE

(71) Applicants: Matthew David Millard, La Jolla, CA (US); Richard James Millard, Colorado Springs, CO (US)

(72) Inventors: Matthew David Millard, La Jolla, CA (US); Richard James Millard, Colorado Springs, CO (US)

(21) Appl. No.: 13/856,527

(22) Filed: Apr. 4, 2013

Related U.S. Application Data
(60) Provisional application No. 61/790,141, filed on Mar. 15, 2013.

(51) Int. Cl. E05D 11/10

(52) U.S. Cl. CPC E05D 11/1007
USPC 16/326

(57) ABSTRACT

In various exemplary embodiments, a hinge or clamp comprising a first leaf and a second leaf comprising complimentary knuckles that move rotationally relative to each other about a longitudinal axis of a bore formed by the complimentary knuckles. A locking mechanism located on or within one of the knuckles can move axially along the longitudinal axis of the bore, the locking mechanism comprising a first engagement structure and configured to move rotationally with the leaf comprising the knuckle it is located on or within, the first engagement structure configured to engage a complimentary second engagement structure located on or within an adjacent knuckle, a biasing mechanism that urges the locking mechanism axially along the longitudinal axis of the bore in a direction to engage the first and second engagement structures, and a release post that can be pressed to urge the locking mechanism axially along the longitudinal axis of the bore in a direction to disengage the first and second engagement structures.

This application claims the benefit of U.S. Provisional Patent Application No. 61/790,141 filed on Mar. 15, 2013, and which is hereby incorporated by reference in its entirety as if set forth herein.

### BACKGROUND OF THE INVENTION

1. Field of the Invention

The invention relates generally to the field of locking hinges and clamps. In particular, the invention relates to a releasable locking hinge that can be used as a hinge and/or clamping device.

2. Description of Related Art

There is often a need for a hinge mechanism that can be locked in a specific position, but prior art locking hinges are complex, and limited in their functionality. Many prior art locking hinge mechanisms require the user to actuate a button or pin on the hinge mechanism to manually select the relative position of the hinge leafs. In addition, many prior art locking hinge mechanisms are comprised of a large number of parts, increasing cost, reducing reliability, and requiring bulky housings. The present invention provides a simple, effective releasable lockable hinge mechanism that allows the user to select the relative position of the hinge leafs by moving the hinge leafs or items mounted to the hinge leafs. The resulting device can be used in a variety of different configurations, including without limitation as a locking hinge and a clamping device.

### SUMMARY OF THE INVENTION

In various exemplary embodiments, a hinge or clamp comprising a first leaf and a second leaf comprising complimentary knuckles that move rotationally relative to each other about a longitudinal axis of a bore formed by the complimentary knuckles. A locking mechanism located on or within one of the knuckles can move axially along the longitudinal axis of the bore, the locking mechanism comprising a first engagement structure and configured to move rotationally with the leaf comprising the knuckle it is located on or within, the first engagement structure configured to engage a complimentary second engagement structure located on or within an adjacent knuckle, a biasing mechanism that urges the locking mechanism axially along the longitudinal axis of the bore in a direction to engage the first and second engagement structures, and a release post that can be pressed to urge the locking mechanism axially along the longitudinal axis of the bore in a direction to disengage the first and second engagement structures. In various exemplary embodiments, the hinge or clamp further comprising a second biasing mechanism that urges the first leaf and the second leaf to move away from each other, or further comprising a second biasing mechanism that urges the first leaf and the second leaf to move toward each other. In various embodiments, the engagement structures comprises angled teeth that engage complimentary grooves in the other engagement structure, and the angled teeth may be configured to allow the first leaf and the second leaf to move toward each other or away from each other when the release post is not being pressed. In various embodiments, the biasing mechanism is a spring such as a coil spring.

### BRIEF DESCRIPTION OF THE DRAWINGS

FIG. 1 is a perspective view of an exemplary embodiment of the hinge/clamp device in a partially open position.

FIG. 2 is a perspective view of an exemplary embodiment of the hinge/clamp device in a partially closed position relative to FIG. 1.

FIG. 3 is an exploded view of an exemplary embodiment of a hinge/clamp device in accordance with the invention.

FIG. 4 is an exploded view of the same exemplary embodiment of a hinge/clamp device as FIG. 3 from another angle.

FIG. 5 is a partially transparent view of the same exemplary embodiment of a hinge/clamp device as FIG. 3, shown in the locked position.

FIG. 6 is a partially transparent view of the same exemplary embodiment of a hinge/clamp device as FIG. 3, shown in the unlocked position.

FIG. 7 is an exploded view of an exemplary embodiment of a mechanism for fixing the release post in a disengaged position.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein. Moreover, while the present invention is discussed herein primarily with respect to a hinge, it will be understood that the present invention can be used in any application in which a releasable locking hinge or clamp is desired. Reference herein to a hinge is for convenience only and does not limit the scope of the invention, which encompasses hinge and clamp mechanisms for use in any appropriate application.

Referring to FIGS. 1 through 6, in various exemplary embodiments, the present invention is a hinge mechanism 100 comprising a first leaf 102 and a second leaf 104, each leaf having knuckles 106, 108, 110 configured to intermesh or interlink with each other. In various exemplary embodiments the first leaf 102 has a first knuckle 106 and a second knuckle 108 spaced apart from each other to receive a single knuckle 110 on the second leaf between them. Each knuckle 106, 108, 110 comprises a bore which, when the knuckles are intermeshed, align to form a barrel 112 of the hinge having a longitudinal axis A. Leaves 102 and 104 may move rotationally relative to each other about longitudinal axis A. It will be readily understood that the first and second leaves 102, 104 can have any number of knuckles, and the first and second leaves described and shown herein are exemplary only.

In various exemplary embodiments, a fixed post 114 having a body 116 sized so that it fits within the barrel 112 and a head 118 sized so that it does not fit within the barrel 112, may be mounted to a knuckle 106 or 108 of the first leaf 102 such that the body 116 is within the barrel 112 and affixed to the first leaf 102. The fixed post 114 can be mounted to the knuckle at either end of the first leaf, but for reference herein it will be mounted to the second knuckle 108 of the first leaf 102, as shown in exemplary embodiment of FIGS. 1 through 6.

In various exemplary embodiments, a spring biased locking mechanism 120 is disposed within middle knuckle 110. Locking mechanism 120 is biased along the longitudinal axis A, generally in the direction away from fixed post 114. In various exemplary embodiments, fixed post 114 may provide support for the biasing device. A biasing device 122, such as a coil spring located inside the barrel 112 exerts a biasing force against the locking mechanism 120. It will be readily understood that the invention is not limited to use of a coil spring, but rather that any type of biasing device may be used including any type of mechanical spring or resilient material. It will be further understood that the biasing device does not need to be supported by the fixed post 114, but rather could be supported by any other suitable structure.

In various exemplary embodiments, locking mechanism 120 comprises a post region 124 and a locking region 126. Locking mechanism 120 is adapted to fit into the middle of knuckle 110 so that it can move longitudinally within the barrel 112 along axis A, but moves rotationally about longitudinal axis A together with the second leaf 104. In various exemplary embodiments, a proximal section of bore 128 of the middle knuckle 110 has longitudinal grooves 130 extending radially outward from bore 128. The post region 124 of locking mechanism 120 may have complimentary longitudinal ridges 132 extending radially to engage the longitudinal grooves 130 such that locking mechanism 120 moves rotationally about longitudinal axis A together with second leaf 104. It will be readily understood that any other suitable structure that allows the locking mechanism 120 to move axially along longitudinal axis A with respect to middle knuckle 110 of second leaf 104, but fixes locking mechanism 120 rotationally with respect to middle knuckle 110 of second leaf 104 may be used.

In various exemplary embodiments, locking region 126 comprises a first engagement structure 134 that can engage a complimentary second engagement structure 136 on first knuckle 106. In an exemplary embodiment locking region 126 has a circumference that may be greater than post region 124, and a first engagement structure 134 comprising angled teeth located on the distal end of locking mechanism 120 on the annular surface outside the circumference of the post region 124. The distal section of bore 128 has a circumference slightly greater than the circumference of locking region 126 so that the locking mechanism can move longitudinally along axis A from an unlocked position wherein the first engagement structure 134 on the locking mechanism is completely disengaged from second engagement structure 136 on the first knuckle 106, to a locked position wherein the first engagement structure 134 is fully engaged with second engagement structure 136. In various exemplary embodiments, second engagement structure 136 may be a separate component as shown in FIGS. 3 through 6, or it may be integrated into the knuckle.

At rest, the biasing device 122 urges the locking mechanism 120 distally along longitudinal axis A, causing first engagement structure 134 on the locking mechanism to engage second engagement structure 136 on the first knuckle 106 in a locked position. In this locked position, first leaf 102 and second leaf 104 can move radially toward each other as the angled teeth 138 urge the locking mechanism 120 in a proximal direction along longitudinal axis A, overcoming the bias exerted by biasing device 122 as they move to the next complimentary groove in the second engagement structure 136. Continued rotational force on leaves 102 and 104 will cause the angled teeth of first engagement structure 134 to continue to ratchet along the grooves of second engagement structure 136 until they can travel no farther or reach a mechanical stop.

In the resting locked position, however, first leaf 102 and second leaf 104 cannot move radially away from each other. In the locked position, the non-angled back sides of angled teeth 138 do not urge the locking mechanism 120 in a proximal direction along longitudinal axis A to overcome the spring bias, but rather engage the grooves of second engagement structure 136 and prevent rotational movement of the first and second leaves. Thus, in various exemplary embodiments the first leaf 102 and second leaf 104 can move rotationally relative to each other in one direction, but will be locked against movement in the other direction, depending on the orientation and configuration of the angled teeth 138.

In the accompanying figures, the first engagement structure 134 is shown as angled teeth and the second engagement structure 136 is shown as complimentary grooves in second knuckle 108 that engage the angled teeth to create a ratcheting engagement between the two structures. It will be readily understood that the size, depth, shape, and angles of the teeth and complimentary grooves on the engagement structures can be modified, adjusted, and arranged in a wide array of different configurations to control the locking and movement of the two leaves. For example, the configuration of the angled teeth 138 can be reversed to provide a device that allows first leaf 102 and second leaf 104 to move rotationally away from each other, but locks them against rotational movement toward each other. By varying the depth and/or angle of the teeth, the device may be configured to control the amount of force required to move the two leaves rotationally such as providing deeper teeth with a steeper angle such that a larger amount of force must be applied to move the two leaves relative to each other. In various exemplary embodiments, the first engagement structure 134 and second engagement structure 136 can also be configured to lock the hinge against movement in both directions by the use of structures that do not have angled teeth or other geometries that allow for movement in either direction when engaged.

In various exemplary embodiments, a release post 142 having a body 144 sized so that it fits within the barrel 112 and a head 146 sized so that it does not fit within the barrel 112, may be mounted to second knuckle 108 of the first leaf 102 such that the body 144 is within the barrel 112 and the head is distal to the outer side of the second knuckle 108. The body 144 of the release post may extend into the barrel 112 such that it contacts the distal end of locking mechanism 120, and may be long enough that the head 146 is positioned some small travel distance D beyond the outer side of the second knuckle 108. Pressure on the head 146 thus urges the locking mechanism 120 in a proximal direction against the spring bias. If the pressure is sufficient to overcome the spring bias, the locking mechanism 120 will move proximally along longitudinal axis A, disengaging the first engagement structure 134 of locking mechanism 120 from the second engagement structure 136 and allowing first leaf 102 and second leaf 104 to rotate freely with respect to each other in either direction.

Referring to FIG. 7, in various exemplary embodiments, release post 142 may further comprise a mechanism to allow it to be fixed in the disengaged position, allowing first leaf 102 and second leaf 104 to rotate freely with respect to each other in either direction. In one exemplary embodiment, such a mechanism may comprise a pin 160 extending outward from the body 144 of the release post 142 that is seated in a groove 162 in the internal wall of the barrel 112. The groove may extend a sufficient distance longitudinally to allow the release post 142 to move longitudinally in the barrel 112 far enough to fully disengage the first and second engagement structures 134, 136, then may extend laterally such that the release post 142 can be rotated so that the pin 160 moves laterally and is then retained in the lateral portion of the groove, preventing the force of the spring bias from pushing out the release post 142 and preventing re-engagement of the first and second engagement structures 134 and 136. Thus, the release post 142 can be pushed in and rotated to fix the locking mechanism 120 in a disengaged position and allow the first leaf 102 and second leaf 104 to rotate freely relative to each other.

In various exemplary embodiments, hinge 100 can further comprise a spring 150 or other biasing device that urges first leaf 102 and second leaf 104 radially away from each other. The force of spring 150 thus must be overcome to urge the two leaves toward each other, and may improve the engagement between the first and second engagement structures. It will be readily understood that such a spring 150 or other biasing device could be used in a wide range of different configurations, and could be configured to urge first leaf 102 and second leaf 104 radially toward each other rather than away from each other.

The present invention can be used in virtually any application that calls for a hinge or clamping device. These include without limitation doors and windows of all types, and clamps used for all types of home, office, medical, and industrial applications.

In various exemplary embodiments, the first leaf 102 and/or second leaf 104 may be provided with a padded or insulated surface. For example, when used for a clamping application, the inner surface of one or both leaves may be equipped with padding or another material to protect the item being clamped or to provide improved frictional engagement.

In other exemplary embodiments, the inner surface of one or both leaves may have a gel pack or other insulating material that can be heated or cooled to provide a warm or cold surface. For example, such a device with a medical gel pack that has been cooled may be clamped onto a patient to provide a cold compress. Such a device may be particularly suited to use on small extremities such as fingers, toes, ears, etc.

It will be further understood that in various exemplary embodiments the invention disclosed herein can be integrated into or attached to other devices for particular applications. For example, in various exemplary embodiments such a device could be integrated into or attached to a rigid surface to provide a clamping mechanism to hold items to that surface. Such applications may include clipboards, clips for affixing documents or other items to display boards, presentations boards, refrigerators, etc.

By varying the configuration and biasing strength of spring 150 and using appropriate first and second engagement structures on the locking mechanism, various exemplary embodiments of the invention can be used in a wide range of other applications, including without limitation locking clamps and/or adjustable mounting devices for woodworking, model building, portable lighting fixtures and flashlights, water bottle or other beverage holders, camera mounts, screens and computer monitors, fans, displays of various types, covers and tops for various containers, etc. In various embodiments on a larger scale, the locking mechanism could be used for a folding table or table leaf, or for an adjustable desk surface.

What is claimed is:

1. A hinge or clamp comprising:
a first leaf and a second leaf comprising complimentary knuckles that move rotationally relative to each other about a longitudinal axis of a bore formed by the complimentary knuckles;
a locking mechanism located on or within one of the knuckles that can move axially along the longitudinal axis of the bore, the locking mechanism comprising a first engagement structure and configured to move rotationally with the leaf comprising the knuckle it is located on or within;
the first engagement structure configured to engage a complimentary second engagement structure located on or within an adjacent knuckle;
a biasing mechanism that urges the locking mechanism axially along the longitudinal axis of the bore in a direction to engage the first and second engagement structures; and
a release post that can be pressed to urge the locking mechanism axially along the longitudinal axis of the bore in a direction to disengage the first and second engagement structures.

2. The hinge or clamp of claim 1, further comprising a second biasing mechanism that urges the first leaf and the second leaf to move away from each other.

3. The hinge or clamp of claim 1, further comprising a second biasing mechanism that urges the first leaf and the second leaf to move toward each other.

4. The hinge or clamp of claim 1, wherein one of the engagement structures comprises angled teeth that engage complimentary grooves in the other engagement structure.

5. The hinge or clamp of claim 4, wherein the angled teeth are configured to allow the first leaf and the second leaf to move toward each other when the release post is not being pressed.

6. The hinge or clamp of claim 4, wherein the angled teeth are configured to allow the first leaf and the second leaf to move away from each other when the release post is not being pressed.

7. The hinge or clamp of claim 1, wherein the biasing mechanism is a spring.

8. The hinge or clamp of claim 7, wherein the biasing mechanism is a coil spring.
